(19) United States
(12) Patent Application Publication
(10) Pub. No.: US 2026/0006544 A1
(43) Pub. Date: Jan. 1, 2026

(54) CELL/PLMN SELECTION

(71) Applicant: InterDigital Patent Holdings, Inc., Wilmington, DE (US)

(72) Inventors: Virgile Garcia, Antibes (FR); Pascal Adjakple, Great Neck, NY (US); Ravikumar Pragada, Warrington, PA (US); Guodong Zhang, Woodbury, NY (US); Kyle Jung-Lin Pan, Saint James, NY (US); Yifan Li, Conshohocken, PA (US); Umer Salim, Vallauris (FR)

(73) Assignee: InterDigital Patent Holdings, Inc., Wilmington, DE (US)

(21) Appl. No.: 19/130,285

(22) PCT Filed: Nov. 15, 2023
(86) PCT No.: PCT/US2023/079796

§ 371 Date: May 15, 2025

Related U.S. Application Data
(60) Provisional application No. 63/425,596, filed on Nov. 15, 2022.

(51) Int. Cl. H04W 48/20

(52) U.S. Cl. CPC H04W 48/20

(57) ABSTRACT

Systems, methods, and instrumentalities are described herein for wireless transmit/receive unit (WTRU) aggregation-based stored selection information for cell selection and public land mobile network (PLMN) selection. Cell selection may be performed using stored selection information from an aggregated device. PLMN selection may be performed using stored selection information from an aggregated device. WTRUs may aggregate their stored selection information for cell selection sharing and/or PLMN selection sharing, for example, to boost a cell selection procedure and/or reduce scanning operations. Aggregated and/or anchor users may verify the validity of stored selection information. A coordinator WTRU may centralize and/or manage aggregated stored selection information.

### CROSS-REFERENCE TO RELATED APPLICATIONS

This application claims the benefit of U.S. Provisional Application No. 63/425,596, filed Nov. 15, 2022, the contents of which is incorporated by reference herein.

### BACKGROUND

Mobile communications using wireless communication continue to evolve. A fifth generation may be referred to as 5G. A previous (legacy) generation of mobile communication may be, for example, fourth generation (4G) long term evolution (LTE).

### SUMMARY

Systems, methods, and instrumentalities are described herein for wireless transmit/receive unit (WTRU) aggregation-based stored information for cell selection and public land mobile network (PLMN) selection. Cell selection may be performed using stored selection information from an aggregated device. PLMN selection may be performed using stored selection information from an aggregated device. WTRUs may aggregate their stored selection information for cell selection sharing, e.g., to boost a cell selection procedure and/or reduce scanning operations. WTRUs may aggregate their stored selection information for PLMN selection sharing, e.g., to boost a cell selection procedure and/or reduce scanning operations. Aggregated and/or anchor users may verify the validity of stored selection information. A coordinator WTRU may centralize and/or manage aggregated stored selection information.

A first device (e.g., a first WTRU) may comprise a processor configured to perform one or more actions. The first device may determine that a condition has been met. The first device may send a request to a second device (e.g., a second WTRU). The request may be for stored information (e.g., stored information that is associated with cell (re) selection). The first device may receive information, which includes the stored information, from the second device. The first device may determine whether the stored information is valid. The first device may perform cell (re) selection using the stored information, for example if the first device determines the stored information is valid.

The first device may determine to perform cell selection. The condition may include a failed cell selection attempt and/or that the first device does not have locally stored information associated with cell (re) selection.

The stored information may include one or more of a cell ID, a cell frequency, a synchronization signal block (SSB), or a synchronization timing.

The information may indicate a location of the second device. The determination of whether the stored information is valid may be based on whether a distance threshold from the first device to the second device is satisfied.

The information may indicate a time of measurement associated with the information. The determination of whether the stored information is valid may be based on whether a delay threshold from the time of measurement is satisfied.

The first device may receive an indication of validity condition(s). The validity condition(s) may include one or more of a supported frequency, a channel, a valid cell ID, a PLMN, a time associated with a measurement, or a location of a measurement. The determination of whether the stored information is valid may be based on whether one or more of the validity conditions are satisfied.

The first device may update locally stored information using the information, for example based on the determination that the stored information is valid.

A first device (e.g., a WTRU) may comprise a processor configured to perform one or more actions. The first device may receive a request, for example from a second device (e.g., a WTRU). The request may be for stored information (e.g., stored information that is associated with cell (re) selection). The stored information may be stored (e.g., locally stored) by the first device. The first device may send information, which may include the stored information, to the second device.

The first device may determine whether the stored information is valid. The first device may send the information if the first device determines the stored information is valid. The first device may not send the stored information, for example, if the first device determines the stored information is invalid.

### BRIEF DESCRIPTION OF THE DRAWINGS

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates an example of a home automation personal IoT network (PIN).

FIG. 3 illustrates an example of wearables PINs.

FIG. 4A illustrates an example of two WTRUs with direct communication without network coverage.

FIG. 4B illustrates an example of two WTRUs with direct communication with network coverage.

FIG. 5 illustrates an example of a control plane protocol stack for cooperation messages.

FIG. 6 illustrates an example of an exchange between two WTRU control plane protocol stacks with Inter-WTRU Cooperation.

FIG. 7 illustrates an example of a control plane protocol stack for Inter-WTRU assistance.

FIG. 8 illustrates an example of an architecture of cooperation with a (e.g., one) non-access stratum (NAS) entity controlling the access stratum (AS) entities of multiple WTRUs.

FIG. 9A illustrates an example of a WTRU coordinator connected to other WTRUs with a direct inter-WTRU connection.

FIG. 9B illustrates an example of a WTRU coordinator connected to other WTRUs without a direct inter-WTRU connection.

FIG. 10 illustrates an example of aggregating stored selection information for cell selection.

FIG. 11 illustrates an example of aggregated stored selection information with transmission-side verification.

FIG. 12 illustrates an example of requesting/using stored selection information for cell selection.

FIG. 13 illustrates an example of aggregating stored selection information for cell selection with a coordinator.

FIG. 14 illustrates and example of public land mobile network (PLMN) selection using aggregated stored selection information.

FIG. 15 illustrates an example of PLMN selection with aggregated stored selection information and Tx-side verification.

FIG. 16 illustrates an example of PLMN selection with aggregated stored selection information on the receiver side.

FIG. 17 illustrates an example of PLMN selection with aggregated stored selection information with a coordinator WTRU.

### DETAILED DESCRIPTION

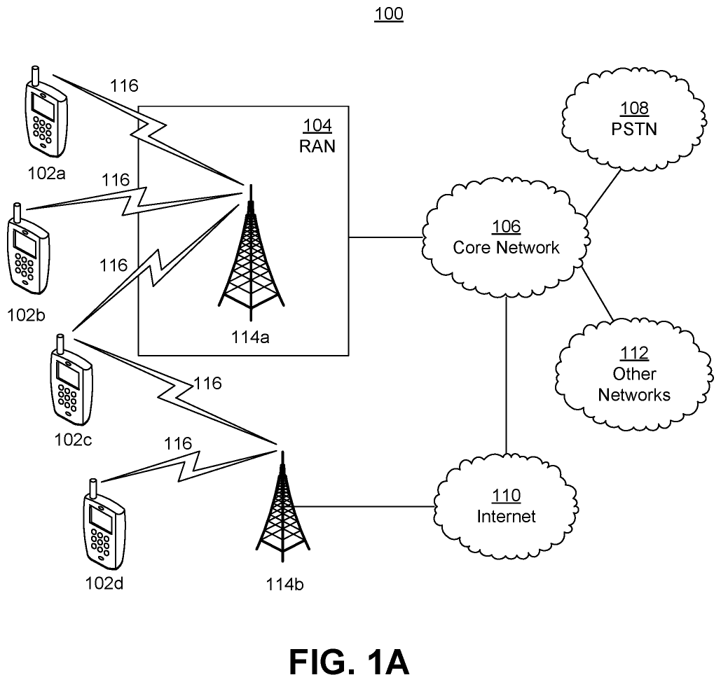

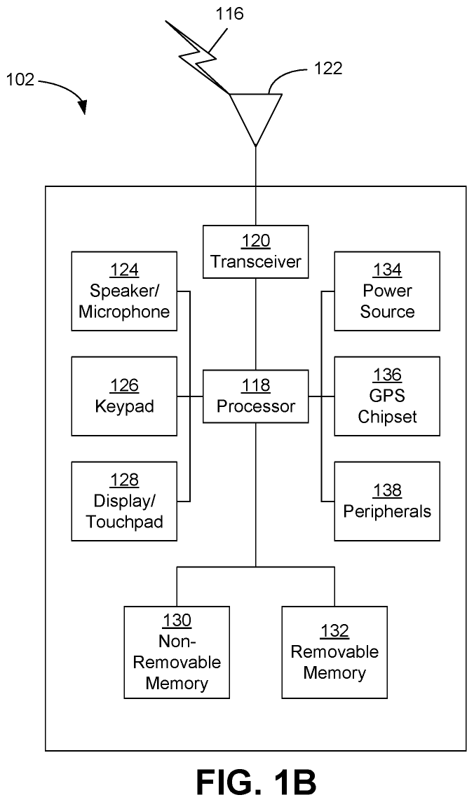

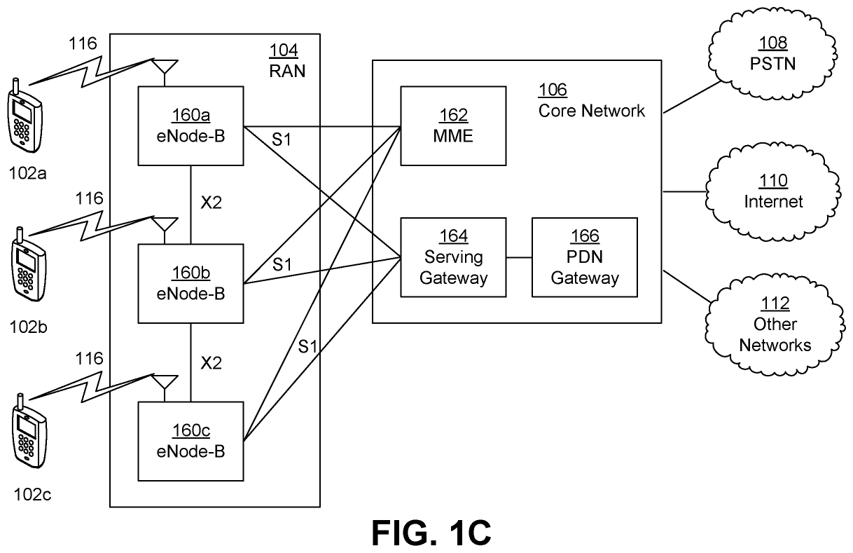

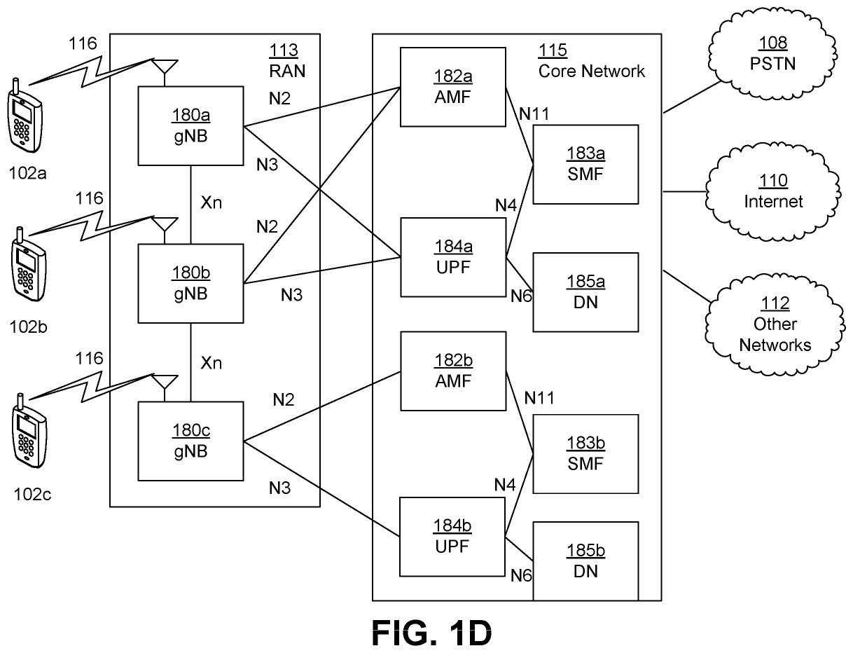

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like.

The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHZ, 2 MHZ, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHz, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

IDLE mode operations may be performed, for example, in 3GPP. WTRUs implementing a radio access technology (RAT), such as one or more of 2G, 3G, 4G, and/or 5G RATs, may perform a public land mobile network (PLMN) selection, a cell selection/re-selection, and/or a location registration (e.g., including tracking area update procedures), for example while in RRC_IDLE mode and/or RRC_INACTIVE mode. Devices (e.g., 5G devices) may (e.g., also) support RAN Notification Area (RNA) updates and/or operation in RRC_INACTIVE state.

A PLMN may be selected by a WTRU. For example, a PLMN may be selected by a WTRU in response to the WTRU being switched on. Associated RAT(s) may be set for a selected PLMN. A WTRU may (e.g., for cell selection) search for a (e.g., suitable) cell of a selected PLMN. A WTRU may choose a (e.g., suitable) cell to provide available services. The WTRU may monitor the control channel of a selected cell. A WTRU may register its presence, for example, based on (e.g., by means of) a NAS registration procedure in the tracking area of the chosen cell.

A WTRU may (e.g., while in RRC_IDLE) perform received signal strength measurements on serving and/or neighbor cells. A WTRU may reselect onto a cell and/or may camp on a (e.g., reselected) cell, for example, if the WTRU finds the cell to be a more suitable cell (e.g., according to cell reselection criteria). Location registration may be performed, for example, if the new cell does not belong to at least one tracking area to which the WTRU is registered. A WTRU may (e.g., also) search for higher priority PLMNs, for example, at regular time intervals and/or, for example, search for a (e.g., suitable) cell based on a condition, such as if another PLMN has been selected by its NAS.

A WTRU may lose coverage of a registered PLMN. A new PLMN may be selected (e.g., automatically) or an indication of available PLMNs may be provided to the user, e.g., so that a manual selection may be performed (e.g., based on a loss of coverage of a registered PLMN). A network may prioritize cell selection onto certain RATs, control the rate at which low, medium, or high mobility WTRUs perform cell re-selection, and/or bar selected tracking areas from re-selection by WTRUs.

A WTRU (e.g., if/when the WTRU camps on a cell in RRC_IDLE state or in RRC_INACTIVE state) may receive system information from the PLMN, establish an RRC connection or resume a suspended RRC connection, and/or receive earthquake and tsunami warning system (ETWS) or commercial mobile alert service (CMAS) notifications. A network may send a control message or may deliver data to a registered WTRU. A network may know (e.g., in most cases) the set of tracking areas in which a WTRU is camped. A paging message may be sent for a WTRU on the control channels of one or more (e.g., all) cells in a corresponding set of tracking areas. A WTRU may receive and may respond to, a paging message from a network.

A PLMN search may be performed. A WTRU may scan one or more (e.g., all) RF channels in the NR bands, for example, according to the WTRU's capabilities to find available PLMNs and available closed access groups (CAGs). A WTRU may search (e.g., on each carrier) for a (e.g., the strongest) cell and read its system information, for example, to find out which PLMN(s) the cell belongs to and any associated CAG(s). A WTRU may (e.g., also) read the system information of one or more (e.g., multiple) cells (e.g., strongest cells), for example, for operation with shared spectrum channel access. A WTRU may (e.g., if the WTRU can read one or several PLMN identities in one or (strongest) more cells), report each found PLMN to the NAS and any associated CAG-ID. A PLMN may be reported as a high quality PLMN without a reference signal received power (RSRP) value based on one or more conditions, such as fulfillment of a high-quality criterion. An example of a high-quality criterion may be a measured RSRP value (e.g., for an NR cell) that is greater than or equal to −110 dBm. Found PLMNs that do not satisfy a high-quality criterion (e.g., although the WTRU has been able to read the PLMN identities) may be reported to the NAS with their corresponding RSRP values and any associated CAG-ID. The quality measure reported by the WTRU to NAS may be the same for each PLMN found in the same cell(s).

A search for PLMNs may be stopped, for example, based on a request from the non-access stratum (NAS). A WTRU may optimize a PLMN search, for example, by using stored selection information. Stored information may include, for example, frequencies and/or information on cell parameters from previously received measurement control information elements.

A WTRU may select a PLMN. A cell selection procedure may be performed (e.g., after PLMN selection), for example, in order to select a (e.g., suitable) cell of the PLMN to camp on.

Cell selection may be performed by initial cell selection and/or cell selection leveraging stored selection information.

Initial cell selection may occur without prior knowledge of which RF channels are NR frequencies. A WTRU may scan one or more (e.g., all) RF channels in the NR bands, for example, according to the WTRU's capabilities, to find a suitable cell. A WTRU may (e.g., on each frequency) search for (e.g., only) the strongest cell(s). A WTRU may search for the next strongest cell(s), for example, for operation with shared spectrum channel access. A WTRU may select a (e.g., suitable) cell found among searched cells.

A cell may be selected by leveraging stored selection information. Stored selection information may include stored information of frequencies and/or cell parameters, e.g., from previously received measurement control information elements and/or from previously detected cells. A WTRU may find a (e.g., suitable) cell. A WTRU may select a found (e.g., suitable) cell. An initial cell selection may be implemented, for example, if a (e.g., suitable) cell is not found.

A WTRU may perform measurements for cell selection and/or reselection purposes (e.g., as described herein).

A WTRU may evaluate Srxlev and Squal of non-serving cells, for example, for reselection evaluation purposes. A WTRU may use parameters provided by the serving cell for the final check on cell selection criterion. A WTRU may use parameters provided by the target cell for cell reselection.

The NAS may control the RAT(s) in which cell selection may be performed, for example, by indicating the RAT(s) associated with the selected PLMN, by maintaining a list of forbidden registration area(s), and/or by maintaining a list of equivalent PLMNs. A WTRU may select a suitable cell, for example, based on RRC_IDLE or RRC_INACTIVE state measurements and/or cell selection criteria.

A WTRU may use stored information for one or more (e.g., several) RATs (e.g., if available), for example, to expedite a cell selection process.

A WTRU may (e.g., regularly) search for a (e.g., better) cell (e.g., according to the cell reselection criteria), for example, if/when camped on a cell. A (e.g., better) cell may be selected, for example, if a (e.g., better) cell is found. A change of cell may imply a change of RAT.

The cell selection criterion S may be fulfilled, for example, based on (e.g., in accordance with) inequality (Ineq.) (1):

$$Srxlev > 0 AND Squal > 0 \qquad ( 1 )$$

Where Srxlev may be provided, for example, in accordance with equation (Eq.)(2) and Squal may be provided, for example, in accordance with Eq. (3):

$$Srxlev = {Q}_{rxlevmeas} - ( {Q}_{rxlevmln} + {Q}_{rxlevmlnoffset} ) - {P}_{compensation} - {Qoffset}_{temp} \qquad ( 2 )$$

$$Squal = {Q}_{qualmeas} - ( {Q}_{qualmin} + {Q}_{qualmlnofset} ) - {Qoffset}_{temp} \qquad ( 3 )$$

Srxlev may be a cell selection RX level value (dB), e.g., as described herein. Squal may be a cell selection quality value (dB), e.g., as described herein.

WTRUs may engage in WTRU grouping/aggregation.

Personal IoT networks (PINs) and/or customer premises networks (CPNs) may provide local connectivity between WTRUs and/or non-3GPP devices. A CPN (e.g., via an evolved residential gateway (eRG)) and/or PIN elements (e.g., via a PIN element with gateway capability) may provide access to (e.g., 5G) network services for the WTRUs and/or other (e.g., non-3GPP) devices on the CPN or PIN. CPNs and PINs may be (e.g., commonly) owned, installed and/or (e.g., at least partially) configured by a customer of a public network operator.

A CPN may be a network located within a premises (e.g., a residence, office, or shop). A CPN may (e.g., via an eRG) provide connectivity to a (e.g., 5G) network. An eRG may be connected to a network (e.g., 5G core network), for example, via wireline, wireless, or hybrid access. A premises radio access station (PRAS) is an example of a base station installed in a CPN. WTRUs may access a CPN and/or (e.g., 5G) network services, for example, through a PRAS. A PRAS may be configured to use licensed and/or unlicensed frequency bands. Connectivity between an eRG and a WTRU, other (e.g., non-3GPP) device, and/or PRAS may use other (e.g., non-3GPP) technology (e.g., Ethernet, optical, WLAN).

A PIN may include PIN elements that communicate using a PIN direct connection and/or direct network connection. A PIN may be managed locally (e.g., using a PIN element with management capability). Examples of PINs may include networks of wearables and/or smart home/smart office equipment. PIN elements (e.g., via a PIN element with gateway (GW) capability) may have access to (e.g., 5G) network services and/or may communicate with PIN elements that are not within range to use a PIN direct connection. A PIN may include at least one PIN element with gateway capability and/or at least one PIN element with management capability.

A PIN element with management capability may be a PIN element that allows (e.g., provides a means for) an authorized administrator to configure and/or manage a PIN.

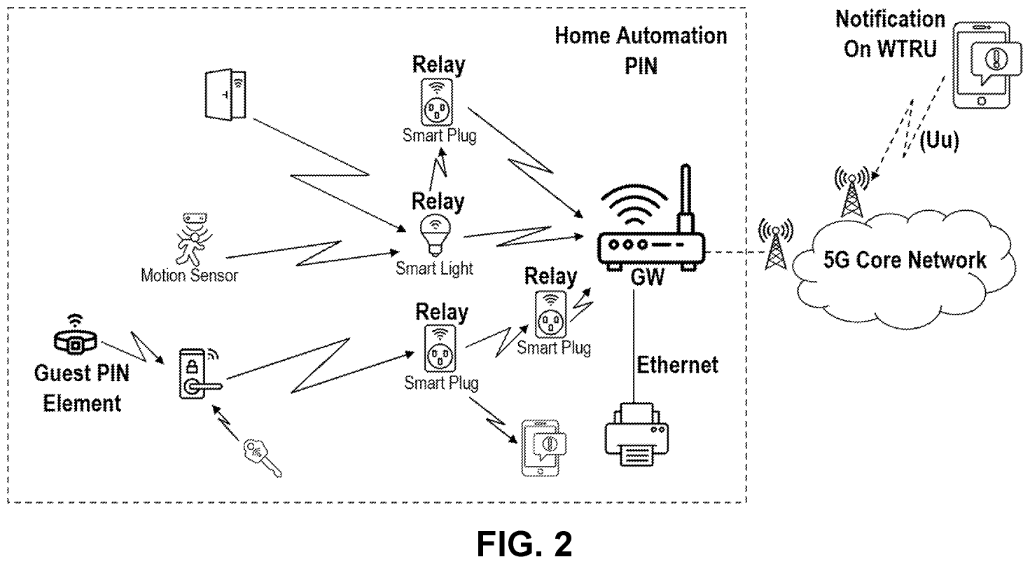

FIG. 2 illustrates an example of a home automation personal IoT network (PIN).

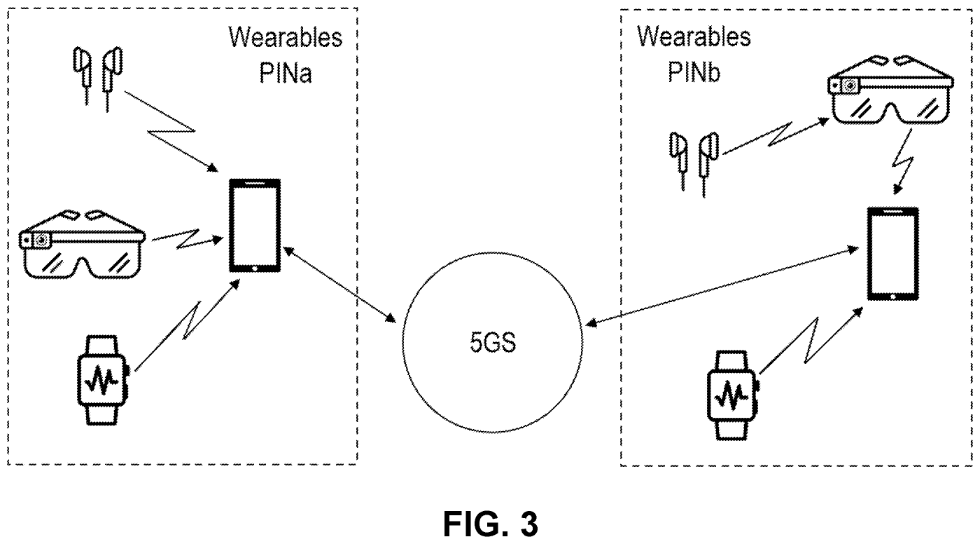

FIG. 3 illustrates an example of a wearables PIN.

WTRU aggregation may refer to an enhancement of a network (e.g., NR) sidelink (SL) relay with one or more (e.g., specific) multi-path properties. A multi-path relay may (e.g., also) be utilized for WTRU aggregation. For example, a WTRU may be connected to the network via a direct path and/or via another WTRU using a non-standardized WTRU-WTRU interconnection. WTRU aggregation may support (e.g., provide) applications involving high UL bitrates on network (e.g., 5G) terminals, for example, if/when (e.g., normal) WTRUs may be too limited by UL WTRU transmission power to achieve a (e.g., required) bitrate, e.g., at the edge of a cell. WTRU aggregation may improve reliability, stability, and/or reduce delay of services. For example, a channel condition of a terminal may be deteriorating. Another terminal may be used to make up for traffic performance unsteadiness caused by a channel condition variation.

WTRUs may spend most of their time in RRC IDLE/INACTIVE mode states. Power consumption associated with IDLE and INACTIVE mode operations may have a significant impact on a WTRU's battery life. Active scanning operations during IDLE and INACTIVE modes, such as scanning a radio channel for PLMN/cell (re) selection, may utilize/drain power in IDLE and INACTIVE modes.

Some devices (e.g., among a wide variety of devices and usages) may be limited (e.g., by their capabilities, power, energy, and/or connectivity) in their ability to access the network (e.g., unlike regular devices). Applications and/or usage may (e.g., also) lead to devices being grouped to deliver their services.

Device performance may be improved, for example, by letting another device assist the device, such as by creating a group or aggregation of devices. Devices may be grouped together, for example, beyond inter-device communication. An “aggregated” device may assist an “anchor” device with one or more of its resources, time, processing power, etc.

Devices in groups may (e.g., often) be close to each other and/or may be associated with (e.g., have requirements of) service from the cells and/or a network provider, such as being served by a specific cell.

Aggregation between WTRUs may be enabled and/or supported in cell or PLMN selection. A (e.g., each) WTRU may (e.g., individually) perform a procedure without input from other WTRUs, which may not leverage one or more relationships to boost cell and/or PLMN selection performance. One or more methods/procedures may be implemented to enable WTRU aggregation and/or procedures performed by WTRUs to support WTRU cooperation. Aggregated WTRUs may leverage their stored selection information across multiple WTRUs to improve performance and/or boost a cell selection and/or a PLMN selection process.

Cooperation may be enabled/implemented between WTRUs in RRC IDLE and/or INACTIVE modes. WTRUs (e.g., in RRC IDLE and/or INACTIVE modes) may cooperate for enablement, signaling, and/or configuration of WTRU aggregation of stored information for cell selection sharing, which may boost a cell selection procedure and/or reduce scanning operations. WTRUs (e.g., in RRC IDLE and/or INACTIVE modes) may cooperate for enablement, signaling, and/or configuration of WTRU aggregation of stored information for PLMN selection sharing, which may boost a cell selection procedure and/or reduce scanning operations. WTRUs (e.g., in RRC IDLE and/or INACTIVE modes) may cooperate for verification of stored information validity by the aggregated and anchor users. WTRUs (e.g., in RRC IDLE and/or INACTIVE modes) may cooperate for enablement, signaling, and/or configuration of a coordinator WTRU centralizing and/or managing aggregated stored information.

An anchor WTRU may be the source or destination of the traffic and payload data. A remote WTRU may be an anchor WTRU, for example, in the context of an (e.g., NR) SL relay. An anchor WTRU may or may not have a direct connection to the network, and/or may (e.g., typically) utilize assistance from other nodes.

An aggregated WTRU may assist/help an anchor WTRU to access the network. The assistance may be, for example, to relay traffic (e.g., an SL relay, such as an NR SL relay) and/or to offload one or more (e.g., certain) tasks and/or procedures from an anchor WTRU.

A coordinator WTRU may manage the cooperation in a group of WTRUs. A coordinator WTRU may be used to offload tasks from other WTRUs, receive or send cooperation information to other devices, assign and/or control tasks performed by other WTRUs, etc. A coordinator WTRU may be used interchangeably with a controller, a manager, or a primary WTRU.

Architecture and cooperation are provided. WTRUs may form in a group. Communication (e.g., PC5 communication or other inter-WTRU connection) may be established between WTRUs. Groups may be set for different applications, services, and/or performance purposes, for example, depending on their configuration. A group may include a coordinator device.

A variety (e.g., several) architectures may be used for inter-WTRU cooperation for RRC IDLE and INACTIVE mode procedures. Inter-WTRU cooperation may be performed, for example, using an inter-WTRU connection, such as PC5 (e.g., Sidelink) or other communication system, which may be standardized outside of 3GPP or non-standardized, such as Wi-Fi, Bluetooth, a wired connection, etc. One or more examples are provided using NR Sidelink (e.g., as a default), although other inter-WTRU interfaces may be used interchangeably, unless mentioned otherwise.

WTRUs may or may not be under the coverage of the network. A connection to a network is not (e.g., always) necessary to perform direct inter-WTRU cooperation.

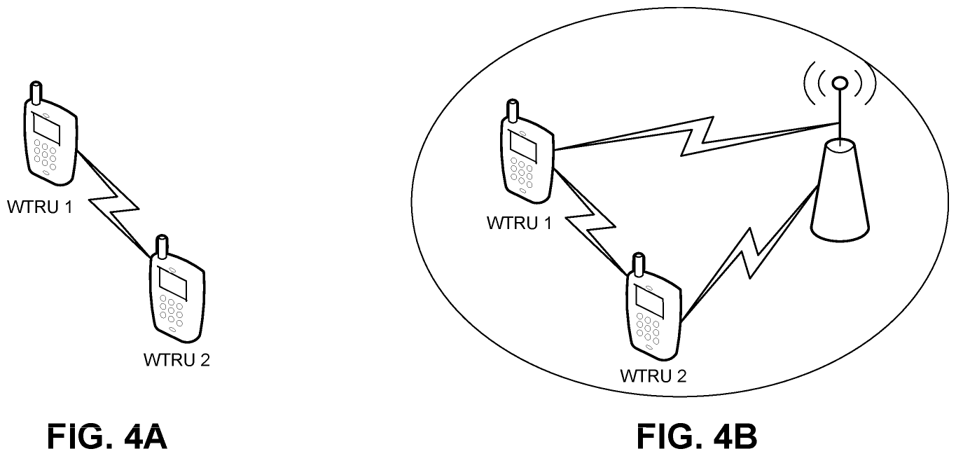

FIG. 4A illustrates an example of two WTRUs with direct communication without network coverage. FIG. 4B illustrates an example of two WTRUs with direct communication with network coverage.

Inter-WTRU communication architecture examples are provided. In an example architecture, multiple (e.g., two) WTRUs may be capable of exchanging information for aggregation over a PC5 link.

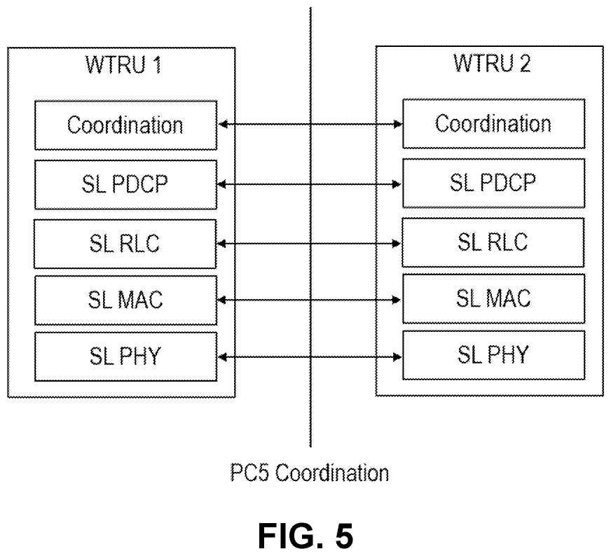

FIG. 5 illustrates an example of a control plane protocol stack for cooperation messages.

The transmission (e.g., between WTRUs) may be performed, for example, using a PC5-cooperation (PC5-C) interface, which may link the cooperation layer in each device via direct PC5 communication e.g., as shown by example in the protocol stack for cooperation in FIG. 5.

A PC5-Cooperation interface may be a dedicated interface, for example, with a dedicated SRB for cooperation information. A PC5-Cooperation may be performed (e.g., alternatively, and interchangeably) using PC5 Signaling (PC5-S) or SL RRC messages (PC5-RRC).

The cooperation may be implemented, for example, as an actual layer in the sidelink protocol stack and/or by reusing the SL Signaling protocol layer or RRC layer. The Cooperation layer may enable cooperation and communication between layers of protocol stacks (e.g., NAS or NR Uu AS control planes) of different WTRUs.

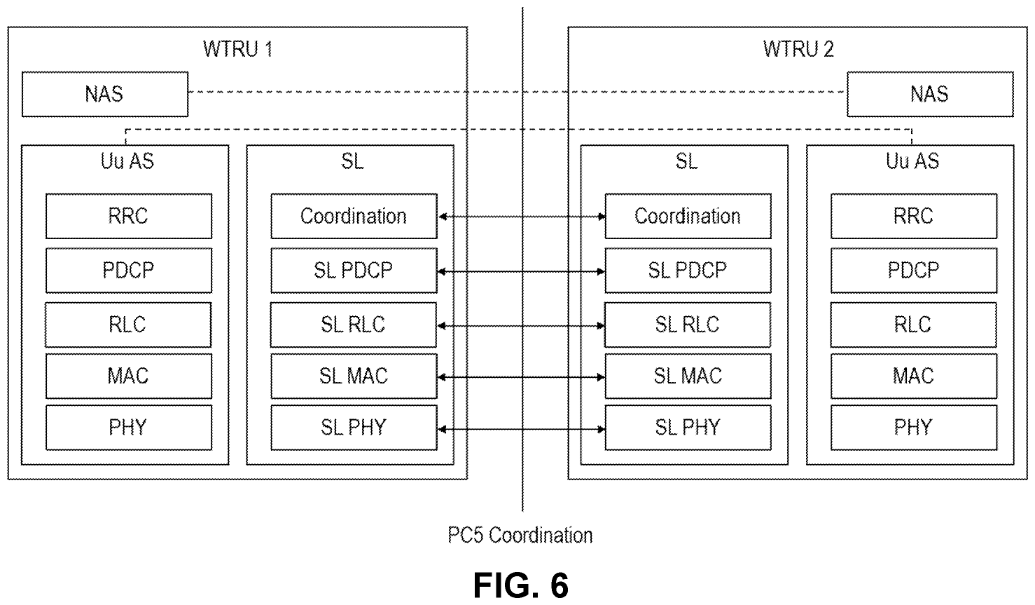

FIG. 6 illustrates an example of an exchange between two WTRU control plane protocol stacks with Inter-WTRU Cooperation. An example of the control plane of the users is depicted in FIG. 6. FIG. 6 shows an example of 3GPP Sidelink inter-WTRU connection. The NAS of WTRU1 may exchange messages with the NAS of WTRU2 via PC5-C. The AS of the different WTRUs may also communicate. The AS and NAS (e.g., for each WTRU) may perform their own task for the connectivity and procedures of the WTRU and may exchange information, which may be used as input for decisions.

WTRUs may (e.g., prior to performing coordinated procedures) exchange signaling to configure how they can coordinate their respective capabilities and communication channels.

A cooperation configuration may include information, such as one or more of the following: available RATs; supported bands/carriers; Uu and SL capabilities; WTRU profile (e.g., WTRU type, power profile); or cooperation capabilities (e.g., which procedures are supported to be coordinated and/or which information requests or sharing are supported).

A WTRU may send direct transmissions to the users in its group, for example, using PC5, unicast, groupcast, and/or broadcast transmissions. Transmissions may be periodic or aperiodic (e.g., depending on the content of the transmission).

A cooperation configuration may include scheduling and/or occasions where a WTRU may (e.g., is expected to) transmit or receive cooperation signaling (e.g., using periodic scheduling, dynamic scheduling, and/or the signaling).

A WTRU may request information from another WTRU at the layer corresponding to the cooperation. For example, a WTRU may send a request over PC5-C and receive a reply/report on PC5-C. A request may be for a one-time report or for (e.g., may trigger) periodic/aperiodic reports (e.g., by subscribing to cooperation content). A WTRU may (e.g., in response to receiving a request) reply with information to report (e.g., if available), for example, after performing related procedures. A WTRU may report to the WTRU that transmitted a request. A WTRU (e.g., that is registered for specific periodic cooperation) may periodically or aperiodically (e.g., based on being triggered by an information update) report to the requesting/registered WTRUs.

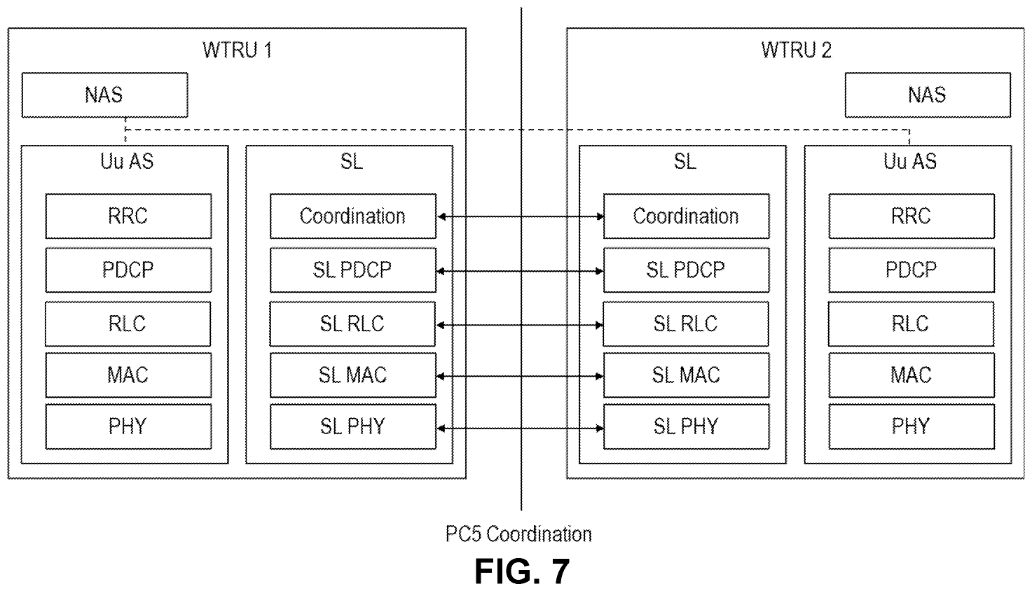

FIG. 7 shows an example of a (e.g., 3GPP) Sidelink inter-WTRU connection. The NAS of WTRU1 may use the AS of (e.g., two) different WTRUs to perform a task and/or may use the AS of another user to perform (e.g., jointly) a task. Similar operations may apply at different layers of the AS.

FIG. 7 illustrates an example of a control plane protocol stack for Inter-WTRU assistance.

Cooperating WTRUs may (e.g., first) coordinate their NAS and AS configurations, e.g., available RATs, supported frequency, and/or procedures. The NAS of the WTRU1 may send a command to the AS of the WTRU2 (e.g., using PC5-C). WTRU2 may perform the procedure or task requested. WTRU2 may (e.g., after completing the procedure or task) report the output to the NAS of WTRU1. Minimal changes/modifications may be made to an operational interface and specification. For example, the content of the reports and commands may be similar to a (e.g., classic) inter-layer communication within a single WTRU. The destinations may be changed to the upper-layer (e.g., or lower-layer) of another WTRU.

In some (e.g., alternative) examples, the NAS of WTRU1 may (e.g., also) perform tasks using the AS of WTRU2, for example, via communication through the NAS layer of WTRU2, which may forward the task to its AS (e.g., transparently and/or by controlling the AS behavior for compatibility with the rest of the WTRU's task).

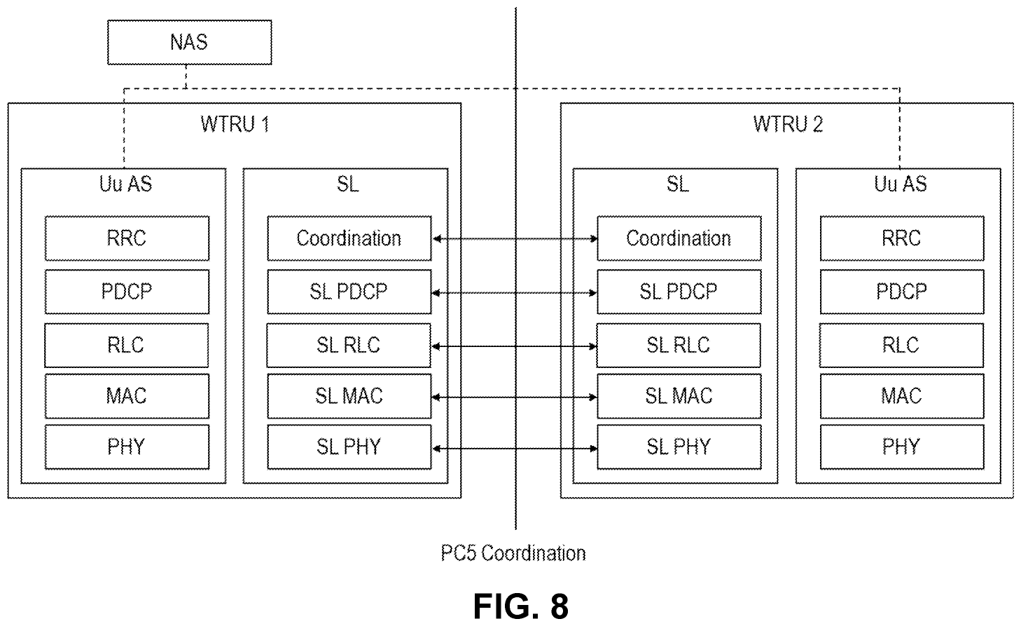

FIG. 8 illustrates an example of an architecture of cooperation with a (e.g., one) NAS entity controlling the AS entities of multiple WTRUs.

As shown by an example architecture illustrated in FIG. 8, a (e.g., single) NAS entity may directly control AS entities of multiple WTRUs, e.g., similar to a Dual Connectivity. The NAS entity may be located within a WTRU (e.g., one of the controlled WTRUs) or in another WTRU. Communication between the NAS and AS layers that are not collocated may be performed using inter-WTRU cooperation, e.g., PC5-C and/or other inter-WTRU links.

Examples are provided for WTRU groups and aggregation. A group of devices may be formed by a service and/or application in a variety of situations and/or services, such as in Personal IoT Networks (PINs), tethered devices (e.g., wearables) or interactive services (e.g., NCIS), etc. Devices in a group of devices may communicate with each other for their services, e.g., in addition to a potential network connection. WTRUs in a group (e.g., in an application and/or service-oriented group) may be selected and/or managed by the service/application, e.g., in a higher layer. Group formation communication exchanges may be configured, for example, during the PC5 connection establishment phase and/or using PC5-RRC or PC5-S types of signaling (e.g., after the connection is established).

In some examples, one or more (e.g., some) of the devices may be limited by their capabilities, power, energy, and/or connectivity to access the network, e.g., as other/regular devices may access the network. WTRUs can be “aggregated. An “aggregated” WTRU may, for example, assist another “anchor” WTRU, for example, to increase the performance of the (e.g., limited) WTRUs. The assistance may be in the form of task offloading and/or relaying. The RAN may (e.g., in this case) perform the grouping of devices (e.g., using PC5-C or Uu signaling), for example, at the WTRU and/or gNB level.

Groups of WTRUs may be dynamic, for example, where WTRUs may be added and removed, e.g., depending on the devices and services.

One or more (e.g., certain) requirements (e.g., performance requirements) and/or connectivity between WTRUs in a group may be configured, for example, depending on the purpose of the group. Requirements may be configured at (e.g., during) the group formation. Information (e.g., related to requirements) may be transmitted, for example, using PC5-C and/or Uu (e.g., if they are managed by the network).

For example, WTRUs in a group may have a connectivity requirement that WTRUs in a group may ensure that they have a direct or indirect connection to one or more other WTRUs in the group (e.g., to a specific WTRU in the group).

For example, WTRUs in a group may have a requirement that the group (e.g., or a part of a group) should be served by the same cell, same gNB, and/or same PLMN, which may be useful for devices that support multi-path (e.g., Uu and SL) but do not support being relayed by a WTRU that is not served by the same cell (e.g., expected SL multi-path Relay feature). This may (e.g., also) be a requirement of the network, for example, to facilitate the management and/or communication with the WTRUs without inter-gNB or roaming exchanges.

A WTRU may be a coordinator/primary WTRU. WTRUs may have multiple (e.g., two) kinds of relationships in a group, for example, depending on the hierarchy between them.

In some examples, WTRUs may be viewed as peers in a group, where there may not be a user managing the others and/or where cooperation within the group may be about sharing information, requesting assistance, and/or forwarding data or control information to each other.

In some examples, there may be primary and secondary devices. Primary devices may act as managing, coordinating, and/or controlling devices for others. Primary devices may centralize the decisions and information in the group and/or may be used to offload tasks or procedures.

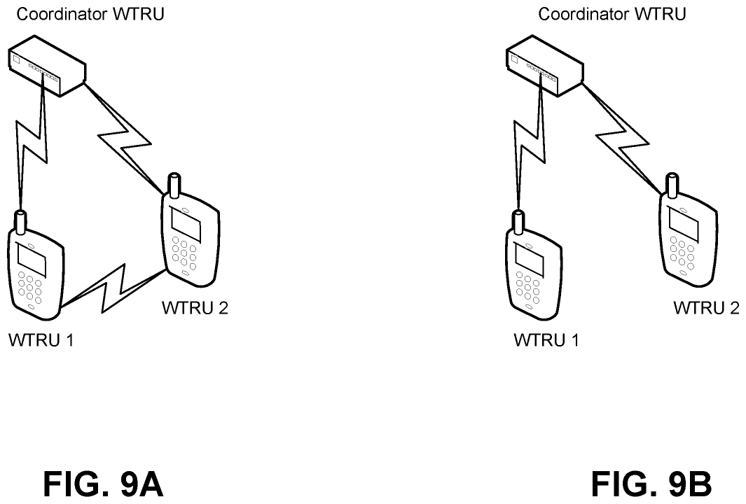

FIG. 9A illustrates an example of a WTRU coordinator connected to other WTRUs with a direct inter-WTRU connection. FIG. 9B illustrates an example of a WTRU coordinator connected to other WTRUs without a direct inter-WTRU connection.

A WTRU may (e.g., also) be used as a coordinator to facilitate the cooperation between other WTRUs (e.g., and itself, if needed), for example, as illustrated in FIGS. 9A and 9B. A coordinator WTRU may (e.g., also) be connected to the other devices and/or may centralize information distribution among the WTRUs. A direct inter-WTRU cooperation link between WTRUs performing a cooperation may not (e.g., always) be necessary, for example, if/when a coordinator WTRU is present.

WTRU information shared between WTRUs of a group may be transmitted through a coordinator WTRU, for example, if/when there is no direct PC5 connection between the WTRUs performing the cooperation or through Uu (e.g., via RRC or higher layer signaling).

A coordinator WTRU may receive cooperation information from WTRUs. A coordinator WTRU may transmit cooperation information to corresponding destinations. A coordinator WTRU may (e.g., also) store cooperation information and/or share it with users, e.g., if/when requested. A WTRU may request (e.g., of/from the coordinator WTRU) information that corresponds to a (e.g., specific) WTRU and/or information for the group.

Cooperation between WTRUs may involve (e.g., require) one or more (e.g., specific) procedures and/or implementation capabilities. One or more (e.g., some) devices may implement (e.g., necessary) features to be a group coordinator. The features may represent a (e.g., specific) WTRU category and/or WTRU class.

In some examples, a device may support (e.g., only) (sub) groups of cooperation features.

WTRU information for aggregation may be shared. Aggregation may be performed between the WTRUs of a group. Information may be shared, for example, so that WTRUs associated with a group know about each other's capabilities and/or status. Information may be used for group cooperation management and/or to determine which WTRU may (e.g., be best to) perform cooperation with another WTRU. Shareable (e.g., shared) information may include, for example, one or more of the following: WTRU capabilities; WTRU stored selection information; WTRU energy/battery status; WTRU location; WTRU inter-connection(s) in the group; WTRU aggregation capabilities; and/or WTRU service type and QoS requirements.

WTRU capabilities information may include, for example, one or more of the following: frequency band support, RAT support, antenna/beam support, measurement capabilities (e.g., information related to how the device can perform a measurement on SSBs and cell search), etc.

WTRU stored selection information may indicate what the WTRU already found previously and/or may quickly find upon performing a stored selection information-based cell selection.

WTRU battery/energy status information may indicate whether the device may (e.g., need to) preserve its energy and/or avoid performing one or more tasks.

WTRU location information may include spatial information (e.g., absolute position, relative position, direction, speed). Spatial information may be useful to determine the proximity between devices, redundancy of their measurements, etc.

WTRU inter-connection(s) in the group may indicate inter-connected WTRUs that can (e.g., easily) share information directly and can update each other.

WTRU aggregation capabilities may include capabilities that support being in a group, capabilities that support being a coordinator, and/or which features and/or procedures are supported to be coordinated, distributed, and/or offloaded.

WTRU service type and QoS requirements may include the type(s) of service to be supported in the group for the user and/or the kind(s) of requirements the WTRU may (e.g., expect to) be assisted with for the group.

Information may be shared between the users, directly or indirectly (e.g., via a coordinator), for example, using PC5-C interface between the AS (e.g., at the RRC level) and/or at the NAS level, e.g., depending on the coordinated procedures. Information can be exchanged during and/or after the PC5 link establishment between the devices and/or when exchanging configuration and/or capabilities about devices. Information may be shared between the users (e.g., periodically and/or on-demand), for example, to update the devices in the group.

Aggregated stored selection information may be used for PLMN/cell selection boosting.

Cell selection may be performed using aggregated stored information. Cell selection can be done in multiple (e.g., two) ways, for example, depending on whether the WTRU has stored selection information. For example, an initial cell selection may scan through one or more (e.g., all) the RF channels and/or bands that the WTRU is capable of, which may be time and/or energy consuming. A WTRU (e.g., with stored selection information for the PLMN/SPMN) may use stored selection information to perform measurements on already known cell configurations, which may speed up the process (e.g., if a suitable cell can be found that way).

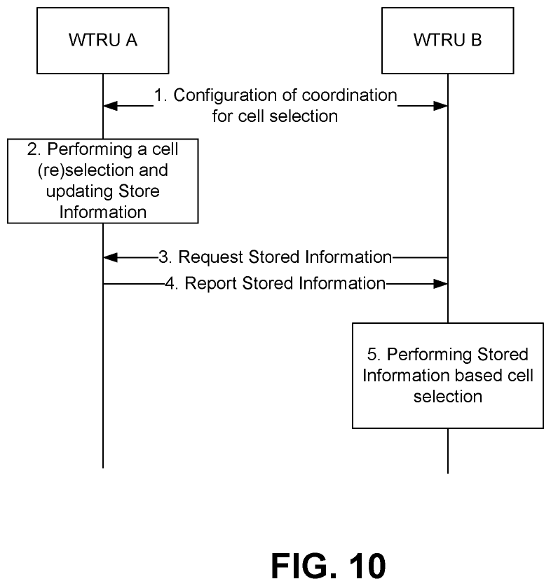

WTRUs in a group may (e.g., in the case of an aggregated cell selection) share their stored selection information, e.g., at least with other WTRUs in proximity, for example, as illustrated in FIG. 10. WTRUs may (e.g., if/when the configuration is compatible and suitable to the receiving device) speed up their cell selection using stored selection information based cell selection, e.g., instead of initial cell selection.

A WTRU may perform (e.g., fall back to) an initial cell selection to perform a full search, for example, if the stored selection information based procedure utilizing other WTRUs' stored selection information does not yield (e.g., help find) a suitable cell.

While examples describe the aggregation of stored selection information for two devices, aggregation may be extended to multiple aggregated devices sharing their stored selection information, e.g., and the anchor device aggregating the multiple values. The multiple aggregated WTRUs may be contacted in parallel, e.g., at the same time, or sequentially, for example, if a (e.g., first) requested stored selection information did not provide useful stored selection information.

FIG. 10 illustrates an example of aggregating stored selection information for cell selection.

As shown in FIG. 10, at 1, WTRUs may be configured and/or enabled to aggregate their stored information for cell selection. The configuration may include the conditions and/or parameters for sharing and/or selecting information to be shared. For example, a parameter may be the validity of stored information in time, e.g., a timer between the measurement and the expiration. A time may be subject to the mobility (e.g., speed) of the device. For example, a parameter may be the maximum distance between the WTRUs to share their information.

At 2, a WTRU may perform measurement(s) for cell selection or reselection and update its stored selection information.

At 3, a WTRU may request that another WTRU share available stored information. The request may include, for example, one or more of the following: desired PLMNs, RATs, carriers or frequencies to be shared, conditions of the validity of the shared measurements (e.g., time and distance validity of the measurements), etc.

At 4, a WTRU may (e.g., after updating its stored information or triggered by a request) transmit its cell selection stored selection information to another WTRU. Stored selection information shared between WTRUs can be frequencies and/or information on cell parameters, e.g., from previously received measurement control information elements. Stored information may (e.g., also) include the WTRU spatial location of the measurement and/or time/age of the measurement, for example, so that other WTRUs may determine its validity. Stored selection information may (e.g., also) indicate the corresponding PLMN of the cell, cell IDs, and/or measured RSRP/RSRQ. Stored selection information may indicate a timing indication about the cell, e.g., absolute or relative timings about the SSBs, and/or SSBs of interest (e.g., based on beam ID or direction). Stored selection information of a WTRU may be useful (e.g., relevant), for example, if/when the WTRUs are close to each other, such as in PIN, IoT, and/or aggregated devices.

In some examples, the received stored selection information may be invalid. A WTRU may request other WTRUs in the group (e.g., and go back to 3 in FIG. 10), for example, if the received stored selection information is not valid.

At 5, the receiving WTRU may use the received stored selection information to perform a stored selection information-based cell selection procedure.

A WTRU (e.g., on the side of the aggregated WTRU that transmits its store information to another WTRU, such as WTRU A in FIG. 10) may (e.g., after completing a cell (re) selection procedure) transmit it to other users of the group, for example, using the PC5-C interface between the AS, e.g., at the RRC level, of the users. The transmission may be limited to newly found cells (e.g., as an incremental update).

In some examples, stored selection information sharing may be triggered by a request. The destination may be the WTRU of a group that requested the sharing of the stored selection information for cell selection. The request and/or the aggregation configuration may include the types of stored selection information to be shared (e.g., cell frequencies, SSB timing, and/or related PLMN).

The WTRU may filter the requested information, for example, to select (e.g., only) the cells information corresponding to the requested PLMN, carriers, and/or RATs from the requesting WTRU.

In some examples, the destination of the stored selection information may be a WTRU that manages the cooperation between the WTRUs of the group.

In some examples, the transmission may be performed using (e.g., 3GPP) sidelink communication towards other WTRUs, e.g., using broadcast, groupcast, and/or unicast transmission(s). A groupcast transmission may set a distance, e.g., until which the transmission is valid.

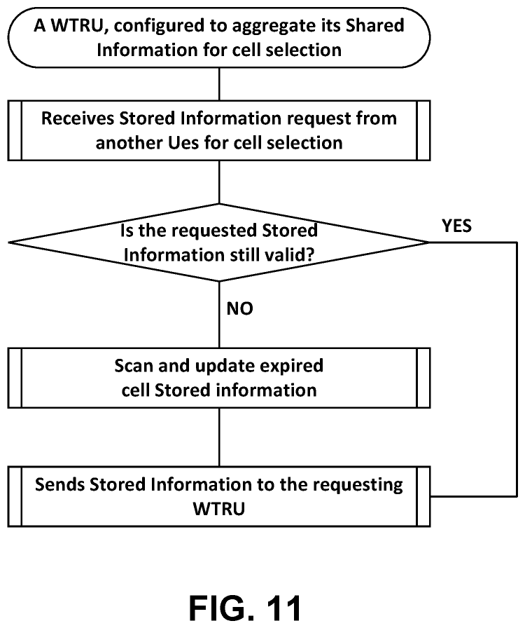

FIG. 11 illustrates an example of aggregated stored selection information with TX-side verification.

In some examples (e.g., as illustrated in FIG. 11), a WTRU receiving a stored selection information request may (e.g., first) validate the stored selection information. Stored selection information may be considered as expired, for example, if the delay or distance since the measurement is beyond a configured threshold and/or if a timer expired. Timing and/or distance thresholds may be configured in a cooperation configuration and/or in a stored information sharing request. A WTRU may perform new measurements for expired information. A WTRU may update its stored selection information before transmitting it to the requesting WTRU.

A WTRU may be on the side of the anchor WTRU receiving and using the stored selection information of another WTRU.

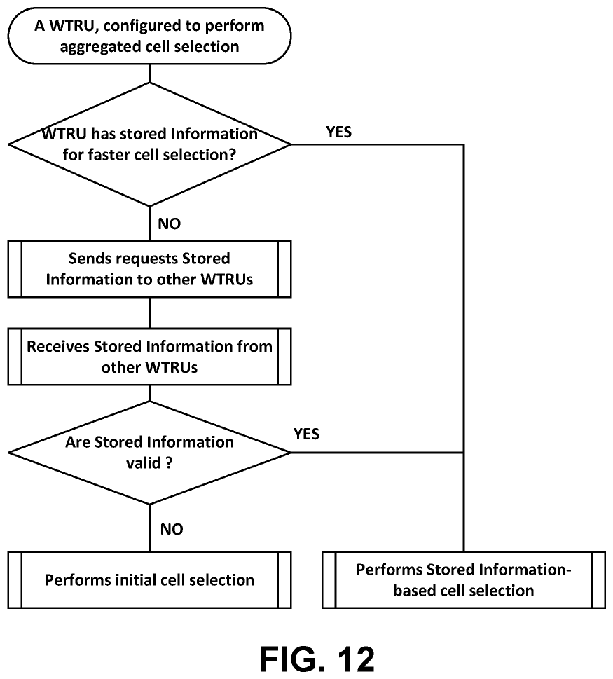

In some examples (e.g., as illustrated in FIG. 12), a WTRU may be configured in a group of users, e.g., where sharing stored selection information for cell selection may be enabled.

A WTRU may (e.g., if/when performing or initiating a cell selection procedure) check for its stored selection information. A WTRU may (e.g., if shared information is not present) transmit a stored information sharing request to other members of the group and/or to a coordinator WTRU. The request and/or the aggregation configuration may include the types of stored selection information to be shared (e.g., cell frequencies, SSB timing, and/or related PLMN) and/or the desired scope of the information (e.g., the RAT, carrier, and/or PLMN selected for the cell selection).

A WTRU (e.g., if/when receiving the stored selection information from users in the group) may check the validity of the stored selection information and/or may store/update the valid stored selection information.

The validity of the stored selection information may be determined based on, for example, a date and/or time of the measurements (e.g., to consider time validity) and/or a location of the measurement (e.g., to avoid considering information from a far/distant location). The criterion for validity and/or parameters may be included in a coordination configuration exchange. A WTRU that receives stored selection information may discard the received stored selection information that is invalid and/or may perform/resume initial cell selection.

A WTRU may (e.g., also) filter and keep (e.g., only) relevant stored selection information relevant for its cell selection, e.g., supported frequencies, channels, valid cell ID, and/or PLMN.

A WTRU may request stored selection information from other devices, for example, if (e.g., a portion or all of) the received stored selection information is not valid.

A WTRU may perform a stored selection information based cell selection, for example, if the WTRU has (e.g., suitable) stored selection information. The WTRU may, otherwise, perform an initial cell selection.

A WTRU may update stored selection information (e.g., received from a user in the group during a cell selection procedure) with compatible (e.g., and suitable) stored selection information received. A WTRU may continue a cell selection with new (e.g., updated) information.

A WTRU may select one or more other WTRUs to send a stored information sharing request, for example, based on the location of the WTRU(s) (e.g., if the distance between the WTRUs is lower than (or equal to) a configured threshold) and/or the inter-WTRU connection (e.g., selecting (only) the WTRU with the strong(est) inter-WTRU link).

FIG. 12 illustrates an example of requesting/using stored selection information for cell selection. Stored information may include frequencies and/or information on cell parameters (e.g., from prior measurement control information elements). The stored information may include WTRU spatial location of the measurement and time/age of the measurement (e.g., so that other WTRUs may determine its validity). The stored information may indicate the corresponding PLMN of the cell, cell IDs and/or measured RSRP/RSRQ. The stored information may indicate a timing indication about the cell, for example, absolute or relative timings about the SSBs (e.g., SSBs of interest, for example based on beam ID or direction). Stored information may be shared between WTRUs. The stored information of a WTRU may be particularly relevant if the WTRUs are close to each other, such as in PIN, IoT, or aggregated devices.

A first WTRU may be configured to perform cell selection (e.g., aggregated cell selection), for example using stored information. The first WTRU may determine to perform cell (re) selection. The first WTRU may determine whether it has stored information (e.g., for faster cell selection), for example as shown in FIG. 12. If the first WTRU has stored information, it may perform cell selection based on the stored information.

The first WTRU may request stored information from a second WTRU (e.g., see FIG. 12), for example if the first WTRU does not have stored information and/or the first WTRU fails a cell selection attempt.

As described herein, the request for stored information may include the types of stored information to be shared (e.g., cell frequencies, SSB timing, related PLMN) and/or the desired scope of the information (e.g., the RAT, carrier, PLMN selected for the cell selection). For example, the request may include the conditions and/or parameters for sharing or selecting information to be shared. A parameter may be the validity of stored information in time (e.g., a timer between the measurement and the expiration). The time may be subject to the mobility (e.g., speed) of the device. A parameter may be a maximum distance between the first WTRU and the second WTRU to share their information.

In examples, condition(s) may be satisfied prior to requesting stored information the first WTRU (e.g., stored information may be requested if the condition(s) are satisfied). Condition(s) may include not having stored information and/or failing a cell selection attempt.

As illustrated in FIG. 12, the first WTRU may receive stored information, for example from the second WTRU.

The first WTRU may determine the received stored information is valid. Validity of the received stored information may be based on a delay and/or a distance since a measurement associated with the stored information. If the delay and/or distance is beyond a configured threshold (e.g., a timer expired), the stored information may be considered as expired and/or invalid. The timing and distance thresholds may be configured in the cooperation configuration and/or in the stored information request.

The first WTRU may receive an indication of validity condition(s) that may be used to determine whether the stored information is valid (e.g., the stored information may be determined as valid if a validity condition is satisfied, multiple validity conditions are satisfied, etc.). The validity condition may include one or more of a supported frequency, a channel, a valid cell ID, a PLMN, a time associated with a measurement, or a location of a measurement. In examples, the stored information may include the validity condition.

If the first WTRU determines the received stored information is valid, the first WTRU may perform cell selection based on the received stored information (e.g., as shown in FIG. 12). The WTRU may filter and/or keep the relevant stored information for its cell selection (e.g., supported frequencies, channels, valid cell ID, PLMN), for example by updating locally stored information. If the stored information based procedure utilizing the second WTRU's stored information does not yield in finding a suitable cell, the first WTRU may perform initial cell selection (e.g., perform a full search).

If the first WTRU determines the received stored information is invalid, the first WTRU may perform initial cell selection (e.g., perform a full search).

In examples, multiple aggregated WTRUs may share their stored information. The multiple aggregated WTRUs may be contacted in parallel (e.g., at the same time), or sequentially (e.g., if a first requested stored information did not provide useful stored information). If the stored information is invalid, the first WTRU may select another WTRU (e.g., a third WTRU) to send a stored information request. The third WTRU may be selected based on the location of the WTRUs (e.g., the distance between the first WTRU and the third WTRU being lower than a configured threshold) and/or the inter-WTRU connection (e.g., only selecting WTRU with strong inter-WTRU link).

Stored information associated with cell (re) selection may be shared between WTRUs. A first WTRU may be configured to perform cell selection (e.g., aggregated cell selection), for example using stored information. The first WTRU may receive a request for stored information (e.g., from a second WTRU for faster cell selection). The request for stored information may include the types of stored information to be shared (e.g., cell frequencies, SSB timing, related PLMN) and/or the desired scope of the information (e.g., the RAT, carrier, PLMN selected for the cell selection).

If the first WTRU has stored information, it may send the stored information. In examples, the first WTRU may be configured to identify stored information to be shared.

The first WTRU may determine if its stored information is valid (e.g., prior to sending the stored information). Validity of the received stored information may be based on a delay and/or a distance since a measurement associated with the stored information. If the delay and/or distance is beyond a configured threshold (e.g., a timer expired), the stored information may be considered as expired and/or invalid. The timing and distance thresholds may be configured in a cooperation configuration and/or in the stored information request from the second WTRU.

In examples, the request may include an indication of a validity condition that may be used to determine whether the stored information is valid. The validity condition may include one or more of a supported frequency, a channel, a valid cell ID, a PLMN, a time associated with a measurement, or a location of a measurement. In examples, the stored information may include the validity condition.

If the first WTRU determines the received stored information is valid, the first WTRU may send/report the stored information to the second WTRU.

If the first WTRU determines the received stored information is invalid, the first WTRU may not send/report the stored information to the second WTRU.

If the first WTRU determines its stored information is expired, the first WTRU may perform new measurements of the outdated expired cells in the stored information and/or update its stored information before transmitting it to the second WTRU.

A WTRU (e.g., having stored selection information) may (e.g., first) try to perform stored selection information-based cell selection. The WTRU may request the stored selection information of other WTRUs, for example, if the WTRU fails to find a suitable cell to camp on.

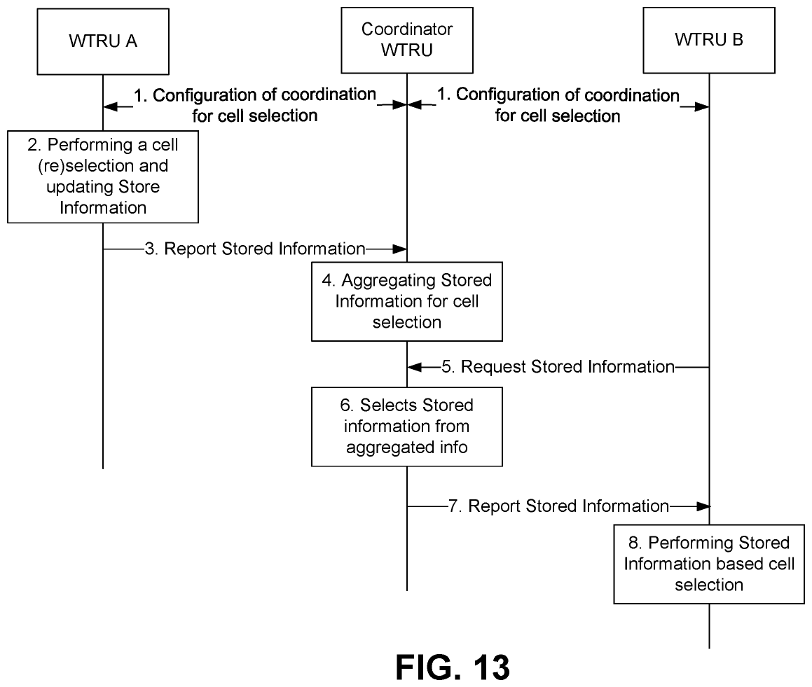

FIG. 13 illustrates an example of aggregating stored selection information for cell selection with a coordinator.

Cell selection may be performed using aggregated stored selection information with a coordinator. A coordinator WTRU may aggregate stored selection information received from other WTRUs. A coordinator WTRU may send aggregated information (e.g., back) to members in the group. A centralized approach may allow better inter-WTRU information sharing efficiency, for example, as illustrated in FIG. 13.

As shown by example in FIG. 13, at 1, WTRUs may be configured and/or enabled to aggregate their stored selection information for cell selection with a coordinator. A configuration related to the coordinator and/or messaging may (e.g., also) be exchanged.

At 2, a WTRU may perform measurement for cell selection or reselection and/or update its stored selection information.

At 3, a WTRU may (e.g., after updating its stored selection information and/or based on being triggered by the coordinator) transmit its cell selection stored selection information to the coordinator. The coordinator WTRU may send requests to other WTRUs to perform selected measurements, e.g., to maintain an updated list of stored selection information. The selection of the cells and/or WTRUs to perform the measurements may be based on WTRU locations and/or expiration of the (e.g., known) stored selection information.

At 4, the coordinator may receive and/or may aggregate the stored selection information from other WTRUs in the group. For example, the coordinator WTRU may receive the stored selection information about a cell that may be considered suitable, while previous stored selection information (e.g., which may or may not be suitable) may have been measured by another WTRU. The aggregation (e.g., by the coordinator WTRU) may update stored selection information with the most recent value and/or with the most optimistic value. The coordinator WTRU may (e.g., also) keep track of values and/or may associate values with the time and/or location of the measurement.

At 5, a WTRU may request that the coordinator WTRU provide stored information. The request and/or the aggregation configuration may include the type(s) of stored selection information to be shared (e.g., cell frequencies, SSB timing, related PLMN, and/or validity).

At 6, the coordinator WTRU may select the stored selection information that best matches the user, e.g., based on the requested information, proximity locations, and/or timing.

At 7, the coordinator WTRU may report the selected stored selection information to the requesting WTRU.

At 8, the receiving WTRU may use the received stored selection information to perform a stored selection information-based cell selection procedure.

PLMN selection may be performed using aggregated stored selection information. A WTRU may optimize a PLMN search, for example, by using stored selection information, e.g., frequencies and/or information on cell parameters from previously received measurement control information elements, which may speed up the search for a PLMN in the different carriers.

WTRUs in a group may (e.g., in case of a cooperative PLMN selection) share their stored selection information, e.g., at least with other WTRUs in proximity. A receiving device may (e.g., if the configuration is compatible and suitable to the receiving device) speed up their PLMN search selection using the stored selection information, for example, instead of scanning through one or more (e.g., all) RF channels of the supported bands.

Stored selection information shared between WTRUs may include frequencies, information on cell parameters from previously received measurement control information elements, WTRU spatial location of the measurement, and/or time/age of the measurement.

While the following example describes the aggregation of stored selection information for two devices, the example may be extended to multiple aggregated devices sharing their stored selection information, e.g., where the anchor device may aggregate the multiple values. The multiple aggregated WTRUs may be contacted in parallel (e.g., at the same time) and/or sequentially (e.g., if a (first) requested stored selection information did not provide useful stored selection information).

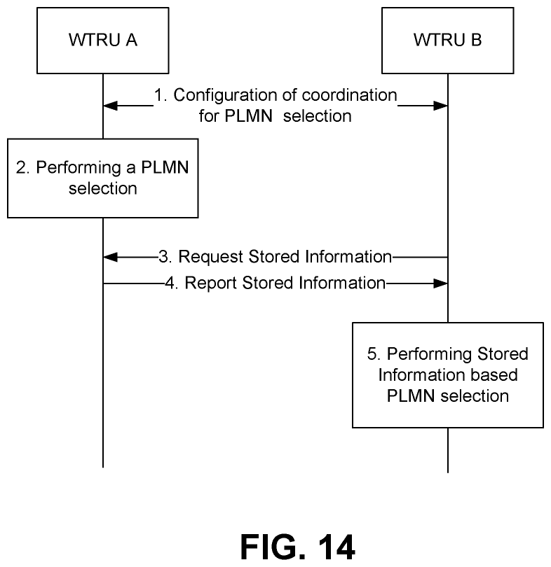

FIG. 14 illustrates and example of PLMN selection using aggregated stored selection information.

As shown in FIG. 14, at 1, WTRUs may be configured and/or enabled to aggregate their stored selection information for PLMN selection. The configuration may include the conditions and/or parameters for sharing and/or selecting information to be shared. For example, a parameter may be the validity of a stored selection information in time, e.g., a timer between the measurement and the expiration. The time may be subject to the mobility (e.g., speed) of the device. For example, a parameter may be the maximum distance between the WTRUs to share their information.

At 2, a WTRU may perform a measurement for PLMN selection and/or update its stored selection information for PLMN selection.

At 3, a WTRU may request another WTRU to share their available stored selection information for PLMN selection. The request may include, for example, desired RATs, carriers and/or frequencies to be shared, and/or conditions of the validity of the shared measurements (e.g., time validity and/or distance validity of the measurements).

At 4, A WTRU may (e.g., after updating its stored selection information or triggered by a request) transmit its cell selection stored selection information to another WTRU. Stored selection information shared between WTRUs may include, for example, frequencies, information on cell parameters from previously received measurement control information elements, WTRU spatial location of the measurement, and/or time/age of the measurement (e.g., so that other WTRUs may determine measurement validity). Stored selection information may (e.g., also) indicate the corresponding PLMN, cell IDs, and/or measured RSRP/RSRQ. Stored selection information may indicate timing indication about the cell, e.g., absolute or relative timings about the SSBs, and/or SSBs of interest (e.g., based on beam ID or direction). Stored selection information of a WTRU may be relevant, for example, if/when the WTRUs are close to each other, such as in PIN, IoT, and/or aggregated devices.

A WTRU may request stored selection information from other WTRUs in the group (e.g., and go back to 3 in FIG. 14), for example, if the received stored selection information is not valid.

At 5, the receiving WTRU may use the received stored selection information to perform a stored information-based PLMN selection procedure. A WTRU (e.g., on the side of the WTRU that transmits its store information to another WTRU, such as WTRU A in FIG. 14) may (e.g., after its PLMN selection procedure or cell selection), update its stored selection information, and/or transmit (e.g., current/valid) stored selection information to other users of the group, for example, using the PC5-C interface between the AS, e.g., at the RRC level, of the users.

In some examples, stored selection information sharing may be triggered by a request. A stored information destination may be the WTRU of a group that requested the sharing of the stored selection information for PLMN selection. The results may be filtered (e.g., by the WTRU providing the stored selection information) to match configured or compatible carriers and PLMN.

The WTRU (e.g., providing the stored selection information) may filter the requested information, for example, to select (e.g., only) cell information corresponding to the requested PLMN, carriers, and/or RATs from the requesting WTRU.

In some examples, the destination of the stored selection information may be a WTRU that manages the cooperation between the WTRUs of the group.

In some examples, the transmission may be performed using a (e.g., 3GPP) sidelink communication towards other WTRUs, e.g., using broadcast, groupcast, and/or unicast transmission(s). The groupcast transmission may set a distance, e.g., until which the transmission is valid.

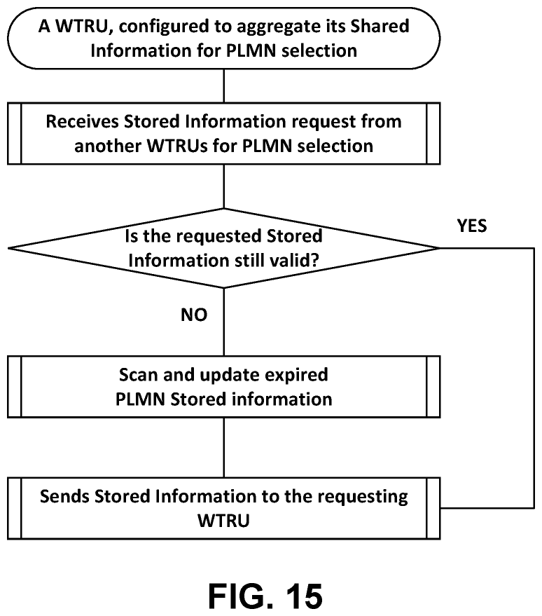

FIG. 15 illustrates an example of PLMN selection with aggregated stored selection information and Tx-side verification.

In some examples (e.g., as illustrated in FIG. 15), a WTRU may receive a stored information sharing request. The WTRU may (e.g., first) validate the stored selection information. The stored selection information may be considered expired, for example, if the delay and/or distance since the measurement is beyond a configured threshold (e.g., or a timer expired). The timing and distance thresholds may be configured, for example, in the cooperation configuration and/or in the stored information sharing request. A WTRU may perform new measurements of expired information. A WTRU may update its stored selection information (e.g., with new measurements) before transmitting it to the requesting WTRU.

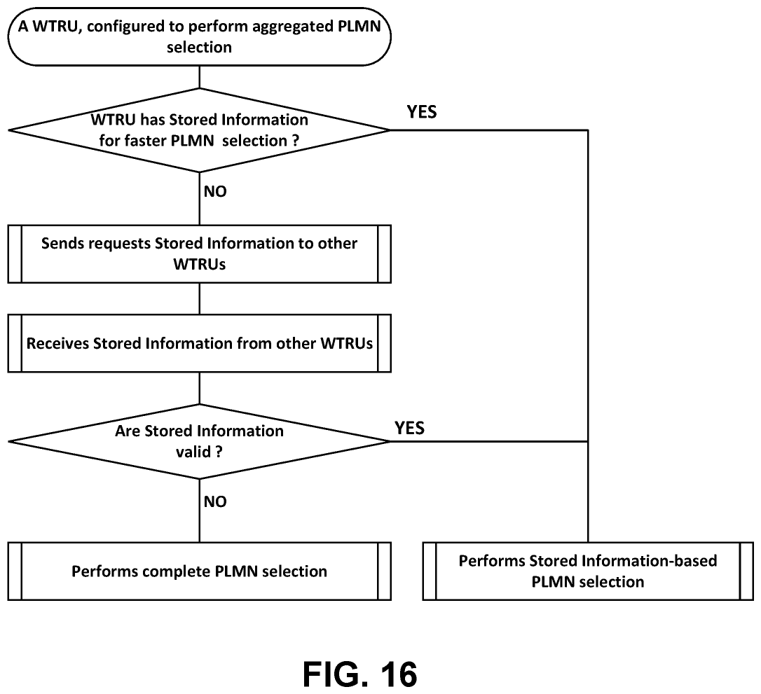

FIG. 16 illustrates an example of PLMN selection with aggregated stored selection information on the receiver side.

A WTRU may be an anchor WTRU that receives and/or uses the stored selection information of another WTRU. In some examples (e.g., as illustrated in FIG. 16), a WTRU may be configured in a group of users, where sharing stored selection information for PLMN selection may be enabled.

A WTRU may (e.g., if/when performing or initiating a PLMN selection procedure) check for its stored selection information. The WTRU may (e.g., if the stored selection information is not present) transmit a stored information sharing request to one or more other members of the group and/or to a coordinator WTRU. The request or the aggregation configuration may include the type(s) of stored selection information to be shared (e.g., frequencies, SSB timing, and/or related PLMN) and/or the desired scope of the information (e.g., the RAT, carrier, and/or PLMN selected for the PLMN selection).

A WTRU may (e.g., if/when receiving stored selection information from users in the group) check the validity of the stored selection information. The WTRU may store/update (e.g., only) the valid stored selection information.

A stored information sharing request may be any messaging suitable for the request of information. For example, the stored information sharing request may include information indicative of the type and/or nature of the requested information. The stored information sharing request may include any data selection mechanism suitable to indicating the type and/or nature of the requested information. For example, the stored sharing request may include data selection mechanisms such one or more data labels, a query, a filter, human-readable selection logic, computer-readable selection logic, one or more ranges (e.g., a temporal range, a geographical range, etc.), and the like. The stored information sharing request may include a general request related to sharable information. The stored information sharing request may include a specific request related to a particular need for sharable information, such as cell and/or PLMN selection, for example. The stored information sharing request may be communicate in a stand-alone message. The stored information sharing request may be communicated as part of a larger message.

The WTRU may update the stored selection information with the valid stored selection information received. The WTRU may resume the PLMN selection, for example, using the stored selection information (e.g., to expedite the search).

The validity of the stored selection information may be determined, for example, based on the date of the measurements (e.g., to consider time validity) and/or the location of the measurement (e.g., to avoid considering information from a far/distant location). The criterion for validity and parameters may be included in the coordination configuration exchange. The WTRU receiving the stored selection information may discard received stored selection information determined to be invalid and/or may perform/resume initial cell selection.

A WTRU may filter stored selection information. A WTRU may keep (e.g., only) relevant stored selection information that is relevant for its cell selection, e.g., supported frequencies, channels, valid cell ID, and/or PLMN.

In some examples, a WTRU may receive stored selection information from a user in the group during a PLMN selection procedure. The WTRU may update the stored selection information with suitable and/or compatible stored selection information received. The WTRU may continue the PLMN selection with the new information.

In some examples, a WTRU (e.g., having stored selection information) may (e.g., first) try to perform the stored selection information-based PLMN selection. The WTRU may request the stored selection information of other WTRUs, for example, if the WTRU fails to find a desired PLMN.

A WTRU may select the WTRUs to send the stored information sharing request to, for example, based on the location of the WTRUs (e.g., if the distance between the WTRUs is lower than a configured threshold) and/or the inter-WTRU connection.

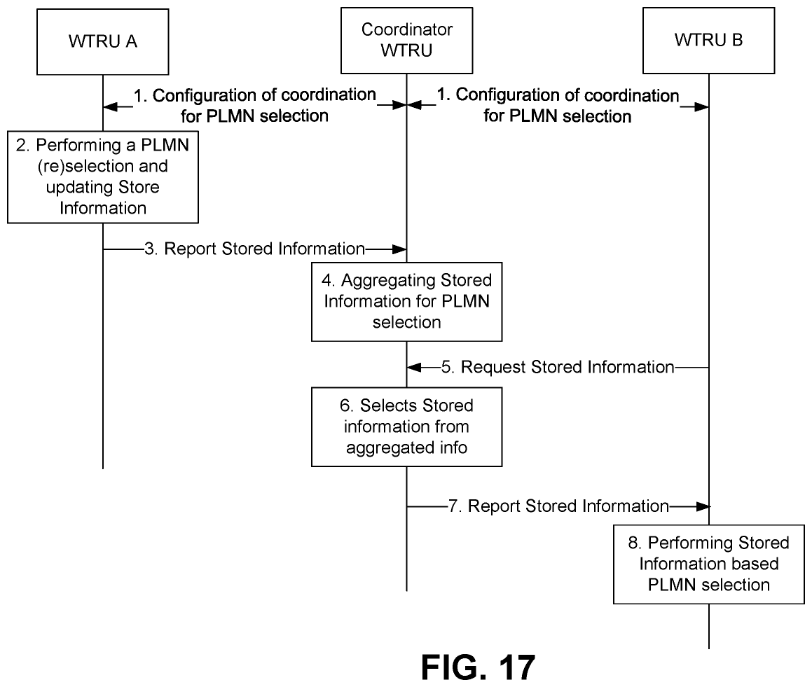

FIG. 17 illustrates an example of PLMN selection with aggregated stored selection information with a coordinator WTRU.

A coordinator WTRU may aggregate stored selection information for a PLMN selection received from one or more other WTRUs. A coordinator WTRU may send the aggregated information (e.g., back) to members in the group. A more centralized approach (e.g., using a coordinator WTRU) may allow better inter-WTRU information sharing efficiency, for example, as illustrated in FIG. 17.

PLMN selection may use aggregated stored selection information with a coordinator.

As shown in FIG. 17, at 1, WTRUs may be configured and/or enabled to aggregate their stored selection information for PLMN selection with a coordinator. A configuration related to the coordinator and messaging may (e.g., also) be exchanged.

At 2, a WTRU may perform a measurement for PLMN (re) selection. The WTRU may update its stored selection information.

At 3, a WTRU may (e.g., after updating its stored selection information or triggered by the coordinator) transmit its PLMN selection stored selection information to the coordinator.

The coordinator WTRU may send requests to other WTRUs to perform selected measurements, e.g., to maintain an updated list of stored selection information. The selection of the PLMN, RATs, carriers, and/or WTRUs to perform the measurements may be based on WTRU locations and/or expiration of the known stored selection information.

At 4, the coordinator WTRU may receive and/or may aggregate the stored selection information from other WTRUs in the group. The aggregation (e.g., by the coordinator WTRU) may update its stored selection information with the most recent value and/or may combine reports, e.g., to add lists of (e.g., possibly present) PLMNs. The coordinator WTRU may (e.g., also) keep track of the measurements and/or may associate them with the time and/or location of the measurement.

At 5, a WTRU may request that the coordinator WTRU provide stored information. The request and/or the aggregation configuration may include the type(s) of stored selection information to be shared (e.g., cell frequencies, SSB timing, and/or validity).

At 6, the coordinator WTRU may select the stored selection information that best matches that user, e.g., based on the requested information, proximity locations, and/or timing.

At 7, the coordinator reports the selected stored selection information to the requesting WTRU.

At 8, the receiving WTRU may use the received stored selection information to perform a stored selection information-based PLMN selection procedure.

Examples are provided for aggregated stored selection information for cell selection.

In some examples (e.g., as illustrated in FIG. 12), a WTRU may be configured in a group of users, where sharing stored selection information (e.g., cell frequency, SSB timing indication, and/or SSB index) for cell selection may be enabled.

The WTRU may check for its stored selection information, for example, if/when performing or initiating a cell selection procedure. The WTRU may perform stored selection information based cell selection, for example, if the WTRU has stored selection information. The WTRU may transmit a stored information sharing request (e.g., including the desired PLMN, RAT, and/or carriers supported by the WTRU), for example, if the WTRU fails to find a suitable cell (e.g., during stored selection information based cell selection) or if the stored selection information is not present.

The request may be sent to a coordinator WTRU that centralizes the stored selection information for the group, and/or selected WTRUs, for example, based on their WTRU information (e.g., distance, capabilities, connection).

A WTRU may (e.g., if/when receiving stored selection information from the other WTRU) check the validity of the stored selection information (e.g., check the expiration date and/or whether the distance between the WTRUs is lower than a configured threshold). The WTRU may store/update the valid stored selection information.

The WTRU may perform a stored selection information based cell selection, for example, if the WTRU has valid stored selection information. The WTRU may, otherwise (e.g., if the stored selection information is invalid), perform an initial cell selection.

In some examples (e.g., as illustrated in in FIG. 11), a WTRU may be configured to share its stored selection information with another WTRU for cell selection. The configuration may include a time validity and/or a distance validity for which the stored selection information can be shared. A WTRU may receive a stored information sharing request, e.g., for one or more RATs, carriers, and/or PLMNs. The WTRU may verify the validity of the stored selection information for the request. The WTRU may perform a measurement of the cells that are outdated. The WTRU may update its stored selection information (e.g., based on new measurements). The WTRU may transmit the report to the requesting WTRU. The WTRU may (e.g., before transmitting the report) filter the carriers, RATs, and/or PLMNs, for example, according to the configured information to be shared, the supported and/or desired information by the requesting WTRU.

In some examples (e.g., as illustrated in FIG. 13), a coordinator WTRU may be configured to aggregate stored selection information for cell selection from WTRUs in a group, which may include timing and/or spatial validity of the stored selection information. The coordinator WTRU may request other WTRUs to perform measurements of one or more (e.g., specific) cells, for example, to verify and/or update the aggregated stored selection information, e.g., based on their previous report, time, and/or location. The coordinator WTRU may receive the stored selection information for cell selection from the WTRUs. The coordinator WTRU may aggregate the stored selection information. For example, a first WTRU may report that a given cell is suitable while previous stored selection information may have been measured and/or indicated to be not suitable by a second WTRU. An aggregation (e.g., by the coordinator WTRU) may update stored selection information with the most recent value and/or or with the most optimistic value. An aggregation (e.g., by the coordinator WTRU) may update or remove information, for example, based on the validity configuration. A coordinator WTRU may keep track of multiple values and/or may associate the values with the time and/or location of measurements. A coordinator WTRU may receive a request from one or more WTRUs to send the aggregated stored selection information. A coordinator WTRU may (e.g., if/when the Coordinator WTRU transmits the stored selection information to a WTRU) select the stored selection information that best matches the user, for example, based on proximity locations and/or timing. A coordinator WTRU may filter the results for the carriers, RATs, and/or PLMNs, for example, according to the configured information to be shared, the supported and/or desired information by the requesting WTRU.

Examples are provided for aggregated stored selection information for PLMN selection.

In some examples (e.g., illustrated in FIG. 14), a WTRU may be configured in a group of users, where sharing stored selection information for PLMN selection may be enabled.

A WTRU may check for its stored selection information, for example, if/when performing or initiating a PLMN selection procedure. The WTRU may perform a stored selection information based PLMN selection, for example, if the WTRU has stored selection information. The WTRU may transmit a stored information sharing request, which may include the desired PLMN, RAT, and/or carriers supported by the WTRU, for example, if the WTRU fails to select a suitable PLMN (e.g., during a stored selection information based PLMN selection) or if the stored selection information is not present.

The request may be sent to a coordinator WTRU that centralizes the stored selection information for the group, and/or to selected WTRUs, for example, based on their WTRU information (e.g., distance, capabilities, and/or connection).

A WTRU may (e.g., if/when receiving stored selection information from another WTRU) check the validity of the stored selection information (e.g., by checking the expiration date and/or whether the distance between the WTRUs is lower than a configured threshold). The WTRU may store/update the valid stored selection information.

The WTRU that received the stored selection information may perform a stored selection information based PLMN selection, for example, if the WTRU has valid stored selection information. The WTRU may, otherwise, perform a full PLMN selection.

In some examples (e.g., as illustrated in FIG. 15), a WTRU may be configured to share its stored selection information with another WTRU for PLMN selection. The configuration may include a time validity and/or a distance validity for which the stored selection information can be shared. A WTRU may receive a stored information sharing request for one or more (e.g., some) RATs, carriers, and/or PLMNs. The WTRU may verify the validity of the stored selection information for the request. The WTRU may perform a measurement of the cells that are outdated. The WTRU may update its stored selection information, for example, based on the new measurement(s). The WTRU may transmit the report to the requesting WTRU. The WTRU may (e.g., before transmitting the report) filter the carriers, RATs, and/or PLMNs, for example, according to the configured information to be shared, the supported and/or desired information by the requesting WTRU.

In some examples (e.g., as illustrated in FIG. 17), a coordinator WTRU may be configured to aggregate stored selection information for PLMN selection from WTRUs in a group, which may include timing validity and/or spatial validity of the stored selection information. The coordinator WTRU may request other WTRUs to perform measurements of one or more (e.g., specific) PLMNs, RATs, and/or carriers, for example, to verify and/or update the aggregated stored selection information, e.g., based on their previous report, time, and/or location. The coordinator WTRU may receive the stored selection information for PLMN selection from WTRUs. The coordinator WTRU may aggregate the stored selection information. For example, a first WTRU may report that a PLMN is present in a carrier with high quality while a previous record may not indicate the presence or may indicate the presence without the high-quality criterion satisfied. The coordinator WTRU may update its stored selection information with the most recent value and/or or with the most optimistic value. The coordinator WTRU may update or remove information, for example, based on the validity configuration. The coordinator WTRU may keep track of multiple values and/or may associate the values with the time and/or location of measurement(s). The coordinator WTRU may receive a request from one or more WTRUs to send the aggregated stored selection information. The coordinator WTRU may (e.g., if/when transmitting the stored selection information to a WTRU) select the stored selection information that best matches the user, e.g., based on proximity locations and/or timing. The coordinator WTRU may filter the results for the carriers, RATs, and/or PLMNs, for example, according to the configured information to be shared, the supported and/or desired information by the requesting WTRU.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

What is claimed is:

11. A first wireless transmit/receive unit (WTRU) comprising:
a processor configured to:
determine that a condition has been met;
send a request to a second WTRU, wherein the request is for stored information that is associated with cell selection;
receive the stored information, wherein the stored information comprises a parameter associated with a location of the second WTRU or a time of measurement associated with the stored information;
determine whether the stored information is valid based on whether the parameter satisfies a threshold; and
select a cell based on whether the stored information is valid, wherein selection of the cell comprises performance of an initial cell selection or performance of a cell (re) selection using the stored information.

2. The first WTRU of claim 1, wherein the condition comprises a failed cell selection attempt.

3. The first WTRU of claim 1, wherein the condition comprises that the first WTRU does not have locally stored information associated with cell (re) selection.

4. The first WTRU of claim 1, wherein when the stored information is valid selection of the cell comprises performance of the cell (re) selection using the stored information.

5. The first WTRU of claim 1, wherein when the stored information is not valid selection of the cell comprises performance of the initial cell selection.

6. The first WTRU of claim 1, wherein the stored information comprises at least one of a cell ID, a cell frequency, a synchronization signal block (SSB), or a synchronization timing.

7. The first WTRU of claim 1, wherein the threshold is a distance threshold from the first WTRU to the second WTRU.

8. The first WTRU of claim 1, wherein the threshold is a delay threshold from the time of measurement.

9. The first WTRU of claim 1, wherein the processor is further configured to:
receive an indication of at least one validity condition, wherein the determination of whether the stored information is valid is further based on the at least one validity condition, and wherein the at least one validity condition comprises: a supported frequency, a channel, a valid cell ID, a PLMN, a time associated with a measurement, or a location of a measurement.

10. The first WTRU of claim 1, wherein the processor is further configured to:
based on a determination that the stored information is valid, update locally stored information associated with cell (re) selection using the stored information.

11. A method implemented by a first WTRU comprising:
determining that a condition has been met;
sending a request to a second WTRU, wherein the request is for stored information that is associated with cell selection;
receiving the stored information, wherein the stored information comprises a parameter associated with a location of the second WTRU or a time of measurement associated with the information;
determining whether the stored information is valid based on whether the parameter satisfies a threshold; and
selecting a cell based on whether the stored information is valid, wherein selecting the cell comprises performing an initial cell selection or performing a cell (re) selection using the stored information.

12. The method of claim 11, wherein the condition comprises based on a failed cell selection attempt.

13. The method of claim 11, wherein the condition comprises that the first WTRU does not have locally stored information associated with cell (re) selection.

14. The method of claim 11, wherein the threshold is a delay threshold from the time of measurement is satisfied or a distance threshold from the first WTRU to the second WTRU is satisfied.

15. The method of claim 11, wherein, based on a determining the stored information is valid, selecting the cell comprises performing the cell (re) selection based on the stored information.
